(19) United States
(12) Patent Application Publication
(10) Pub. No.: US 2004/0208539 A1
(43) Pub. Date: Oct. 21, 2004

(54) Dynamic ADD architecture and a method for dynamically adding optical signals to all-optical networks

(76) Inventor: Ben-Zion Kopelovitz, Kfar Saba (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/079,523

(22) Filed: Feb. 20, 2002

(51) Int. Cl. G02B 6/28; H04J 14/02

(52) U.S. Cl. 398/45; 385/24

(57) ABSTRACT

A dynamic ADD architecture and a method to dynamically add optical signals to an all-optical network, specifically an optical ring. Full dynamic configurability of ADD clients connected to an optical ring carrying N optical inputs where, is obtained by using a passive combiner connected with a demultiplexer to provide the ADD functionality. A total of up to M wavelengths (inputs) from the ADD clients, where 1?M?N, are routed into the passive combiner, which outputs a combined ADD signal to the demultiplexer. The demultiplexer sorts each of the M inputs into M sorted optical outputs, which are fed, together with N continuing optical inputs into a N*(2×1) switch. The method and architecture of the present invention provide a fully dynamically configurable OADM using only passive elements.

### FIELD AND BACKGROUND OF THE INVENTION

All-optical (transparent) networks may have different topologies. All topologies share the property that the signal within the boundaries of the all-optical network is photonic, and is not converted into an electronic signal for processing (exceptions may be the OEO transponders at various demarcation points). One very common topology is a ring topology, and more so a dual ring topology. The example below discusses in details the dual ring topology, but in no way is the use of this invention limited to ring topologies.

All-optical (transparent) rings are a natural evolution to Sonet/SDH rings. An all-optical ring is composed of Optical Add Drop Multiplexers (OADMs) connected in a ring topology. In other topologies OTMs (Optical Terminal Multiplexers) or OXCs (Optical Cross-Connects) may be used (e.g., point-to-point and mesh topologies respectively). However ring topologies are very commonly used. The term “all-optical network” topologies is used herein to refer to ring, linear, and other possible topologies connecting OADMs, or other All-optical Network Elements such as OXCs, in which sets of individual DWDM wavelengths on their input ports are rerouted to their output ports. Henceforth, we will discuss rings, as they are the preferred topology, with the understanding that the invention is equally applicable to other topologies and other types of Network Elements.

FIG. 1 depicts a ring topology with three OADM elements 100, 100′ and 100″. The number of elements can be any number, and here three is chosen for simplicity. The elements are connected by an outer ring 102 and an inner ring 104, each ring in the specific example comprised of three fiber optic spans (sections between any two OADM elements). Each fiber carries N wavelengths. Each span enters the OADM from one of two possible inputs, usually named the “EAST side” input or the “WEST side” input. For example, OADM element 100 has an EAST side input 106 on inner ring 104, and a WEST side input 108 on outer ring 102. Signals arriving at the EAST side input are processed inside the OADM. Some wavelengths can be dropped via a DROP module or CONTINUED toward the WEST side. Before leaving the OADM through the WEST output, some wavelengths can be added by an ADD module, and the processed content is leaving the OADM on the WEST side output. Similar processes are carried out on signals arriving on the WEST side and leaving on the EAST side. The ADD and DROP modules are shown as incoming/outgoing short arrows 112 and 114 respectively. In actuality, each arrow represents a collection of M ports.

FIG. 2 is a blowup or general block diagram of an OADM element 200, that is capable to DROP and ADD up to M wavelengths, where M?N. In FIG. 2, an ADD module 202 and a DROP module 204 are functional parts of OADM element 200. A ring fiber 206 enters the OADM at an OADM input 206′ on the left (WEST) and exits the OADM at output 206″ on the right (EAST side), while another ring fiber 208 enters the OADM at an input 208′ on the right (EAST) and exits the OADM at output 208″ on the left (WEST). Fibers 206 and 208 correspond to fibers 102 and 104 in FIG. 1. The signal entering the OADM is processed by the OADM operation. Some wavelengths are DROPPED by the DROP module or CONTINUED, while local signals are added by the ADD module in the wavelengths freed by the drop signals.

An OADM can be realized in various ways. One such way is to demultiplex (DEMUX) the light coming on each of the ring fibers to its N wavelength components, and route each wavelength through a DROP/CONTINUE switch (a switch that in one position routes the wavelength to continue on the ring, and in its other position routes the wavelength toward the DROP ports. Note that a Drop and Continue operation may also be available where some of the wavelength optical power is DROPPED and the rest CONTINUED. However, in such a case the relevant wavelength is not freed for an ADD signal). Then, a second switch (one per wavelength is needed, N switches overall), performs the task of ADDing the wavelength to the OADM output.

FIG. 3 describes the ADD/DROP/CONTINUE signal flow. For the purpose of clarity only the path for one wavelength (out of N) belonging to one fiber is shown. After the signal is decomposed into its wavelength constituents by a DEMUX (not shown), each wavelength, for example an incoming wavelength 304 enters a first (1×2) DROP/CONTINUE switch 306 that can choose whether to send (CONTINUE) incoming wavelength 304 to a second (2×1) ADD switch 312, or to drop the wavelength to a DROP module 310. Second (2×1) ADD switch 312 enables adding a wavelength 314 (from an ADD module 316) toward the direction of a MUX (not shown) through switch 312.

An alternative way, especially when the Drop and Continue operation is not supported by the switches, is described in FIG. 4. In FIG. 4 the two switch arrays of FIG. 3 ((1×2) DROP and (2×1) ADD) are combined into a 2×2 matrix 350. Matrix 350 takes advantage of the fact that a new signal can be ADDed from an ADD module 316′ reusing the same wavelength of a signal that was DROPPED. Therefore there are two logic states to the matrix. A BAR state in which the original signal is CONTINUED, and a CROSS state in which a signal is DROPPED while a new signal can be ADDED on the same wavelength.

Each of the N fibers coming out of the (1×2) switch can either carry a DROP signal (in case its corresponding (1×2) switch is in the DROP position), or not carry a signal (in case the (1×2) switch is in its CONTINUE position). The N fibers are ordered according to their wavelengths. The dropped signals are however connected to “client devices” that are themselves connected to the OADM in either the same order, or some other order. A DROP module 310′ routes the N fibers to one or more client ports. For simplicity, we will refer hereafter to “M client ports”, with the understanding that “M” reflects the total number of wavelengths. Thus, any one client port may be used for various types of inputs: a single wavelength, a group of wavelengths (presently named a “waveband” in the industry), or the complete content of a fiber with many wavelengths, under the condition that the total number of wavelengths M?N.

Two design approaches are available for the DROP module functionality. One OADM design is static in the sense that each DROPPED wavelength is routed to one of M DROP ports using a passive fiber, with this routing being static. The other design approach is to allow the routing of any one of the N DROPPED wavelengths to any one of the M client ports. This provides the OADM with the capability to have the “dynamically configurable DROP” property. One way to implement a “dynamically configurable DROP OADM” is using a NxM non-blocking matrix. Similarly, “clients” are connected in an arbitrary manner to M ADD ports on the ADD module, which routes them to N fibers entering one of the (2×1) switches (the switch is in the ADD position), where M?N, or to the ADD ports of the 2×2 matrix array, or to any other switch array design that can insert wavelength on the output path.

A distinction can be made between a static ADD functionality and a dynamically configurable ADD functionality. In a static ADD design, a client connected to a specific ADD port must have its transmitter “tuned” to that specific wavelength, because the port, being a physical port, is “hard wired” to a specific (2×1) switch, which in turn is “hard wired” to a specific MUX port. This specific MUX port is “tuned” to one and only one wavelength, and rejects all others. A similar discussion is relevant to the 2×2 matrix case as described in FIG. 4.

The other design approach is dynamic. Although clients are statically connected to ADD and DROP ports, in order to make an OADM fully dynamically configurable, one has to provide a way to support all the possible ways to connect “clients” connected on any one of the M ports to any one of the wavelength connections on the (2×1) switches on the (2×1) ADD switch array in FIG. 3, or to any one of the ADD ports of the 2×2 matrix array in FIG. 4.

The configuration of FIG. 3 supports DROP and ADD functions of up to N wavelengths to M ports. In order for an OADM to be dynamically configurable, the requirement is that any one of the N DROPPED wavelengths can be routed to any one of the M DROP ports. Similarly, it should be possible to direct any signal of any client connected on one of the M ADD ports to the (2×1) ADD switch that is on its wavelength path.

The use of a N×M non-blocking switch matrix for achieving the dynamic ADD property (as done for dynamic DROP) is a “standard” solution with at least two major drawbacks: 1) a matrix is an active device, presumably less reliable than a “passive” implementation, as suggested in the present invention, and 2) special software is needed to control the non-blocking matrix in unison with the (2×1) ADD switches (even though a ADD signal with a specific wavelength will always be routed to the same output).

There is thus a widely recognized need for, and it would be highly advantageous to have, a fully dynamically configurable OADM, without resorting to unnecessarily complicated active solutions, such as the use of NxM non-blocking switching matrices in the ADD circuit (along with its special control software).

### SUMMARY OF THE INVENTION

Hereafter, the specification relates to a dynamic ADD capability when it discusses a dynamically configurable OADM. Although the discussion is describing an OADM, it applies to the OADM as an example, with the understanding that, in general, it applies to any other topology where signal need to be “dynamically ADDED” to outgoing DWDM signals.

The present invention is of a dynamic ADD architecture and a method to dynamically add optical signals to an all-optical network, such as an optical ring. The present invention provides a fully dynamically configurable OADM, without resorting to complicated active ADD solutions, such as the use of M×N non-blocking switching matrices in an ADD module, or the use of special control software. In contrast with previous solutions using M×N non-blocking switching matrices, the method of the present invention uses passive elements, thus removing the necessity of complicated software and algorithms for the control of the switches. This method also improves the reliability of the ADD module.

According to the present invention there is provided in an all-optical network, a method for dynamically adding optical signals from at least one client to an optical section carrying N wavelengths, comprising obtaining from the at least one client a combined ADD signal that includes M ADD wavelengths where 1?M?N, and inputting the combined ADD signal to a demultiplexer, the demultiplexer sorting each of the M ADD wavelengths into M sorted optical outputs, whereby the method provides a fully dynamically configurable OADM capability to the all-optical network using solely passive elements.

According to the present invention there is provided, in an all-optical network, a dynamic ADD architecture for dynamically adding optical signals from at least one client to an optical section carrying N wavelengths, comprising a passive combiner for obtaining from the at least one client a combined ADD signal that includes M ADD wavelengths where 1?M?N, and a demultiplexer for receiving the combined ADD signal from the passive combiner and for sorting each of the M ADD wavelengths into M sorted wavelengths each at a proper place, whereby the combination of the passive combiner and the demultiplexer provides a fully dynamically configurable OADM capability to the all-optical network using solely passive elements.

### BRIEF DESCRIPTION OF THE DRAWINGS

The invention is herein described, by way of example only, with reference to the accompanying drawings, wherein:

FIG. 1 depicts a dual-fiber ring with 3 OADM elements interconnected by fiber optic spans;

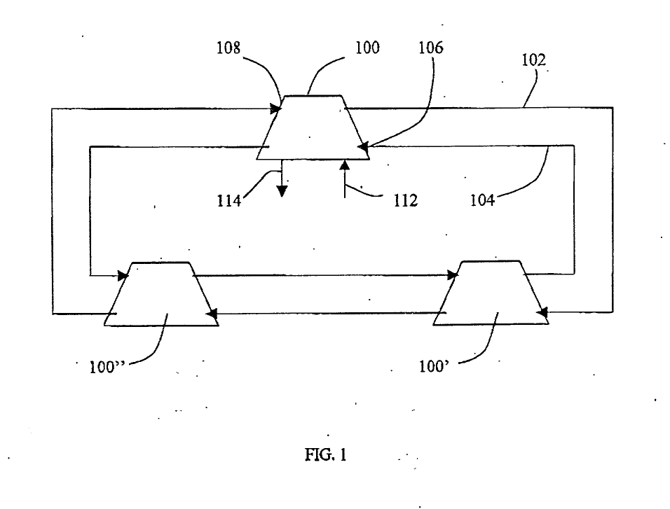

FIG. 2 shows a general block diagram of an OADM, that is capable to DROP and ADD up to M wavelengths;

FIG. 3 describes an ADD/DROP/CONTINUE signal flow;

FIG. 4 describes an ADD/DROP/CONTINUE signal flow in an alternative implementation (to the one presented in FIG. 3).

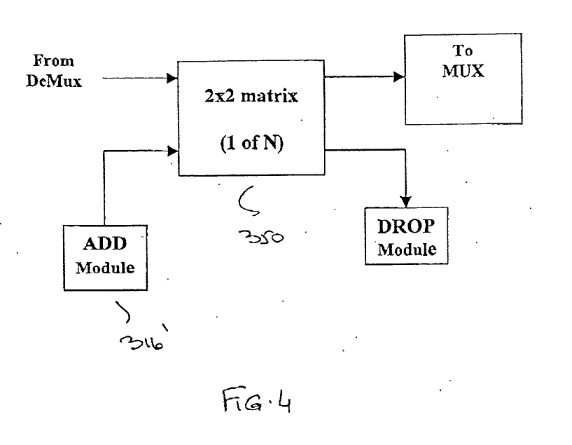

FIG. 5 describes a preferred embodiment of the dynamic ADD architecture of the present invention.

### DESCRIPTION OF THE PREFERRED EMBODIMENTS

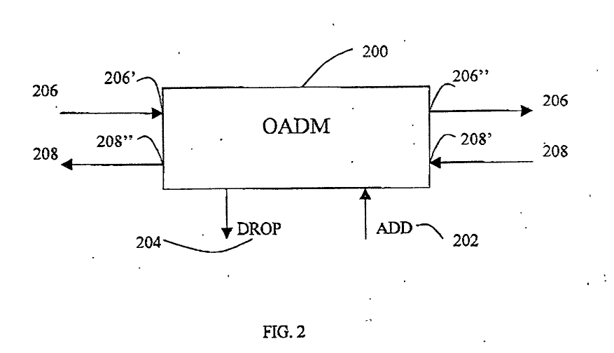

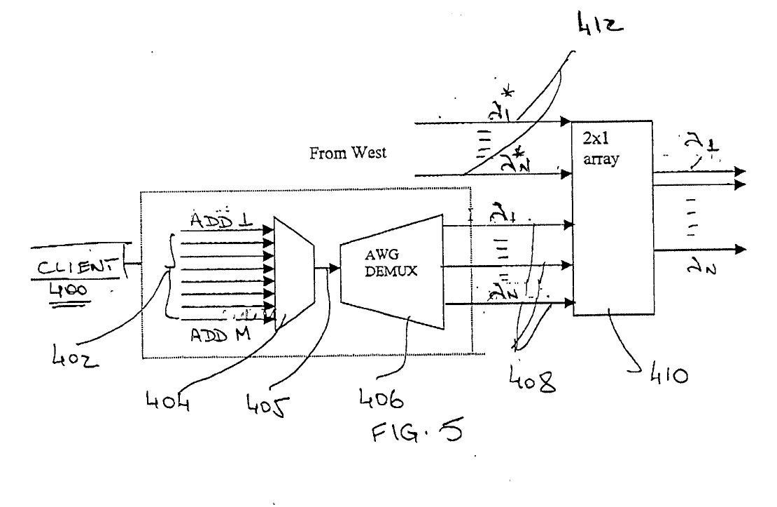

The present invention is of a method and architecture for use in dynamically adding optical signals to an optical ring, or to other topologies using fully dynamically configurable OADM network elements or other all-optical network elements that connect local signals to a WDM network. Specifically, the present invention is of a fully dynamically configurable OADM. Referring now again to the drawings, FIG. 5 describes a preferred embodiment of an efficient architecture to implement a dynamic ADD requirement. At least one input ADD signal 402 (that may include a single wavelength, a group of wavelengths, or the complete content of a fiber with many wavelengths) from at least one client connected to any one of the M ADD ports is first routed to a passive combiner 404. Passive combiner 404 combines together signals 402 into a combined ADD signal 405, which is then routed to a DEMUX 406. Combiner 404+DEMUX 406 together represent a preferred implementation of the ADD functionality in FIG. 2, and thus represent the essence of the present invention. The combination “passive combiner+DEMUX” replaces in essence ADD 202 in FIG. 2, and introduces the major advantage of dynamic configurability to the OADM, while removing the two major drawbacks of the standard solutions listed above in the FIELD AND BACKGROUND section.

Passive combiners (also known as “Couplers” or “Splitters”) are well known in the art. The simplest embodiment of such a combiner is a simple Y-junction that can combine two inputs into one (or split an input into two in the other direction). Cascaded Y-junctions can serve to combine (or split in the other direction) 4, 8, 16, 20, 32, 40, 64, 80, etc. inputs. Commercial couplers include couplers provided by ADC, 13625 Technology Drive, Eden Prairie, Minn. 55344. The various types of inputs that can be routed into the passive combiner were mentioned above: a single wavelength, a group of wavelengths (presently named a “waveband” in the industry), or the complete content of a fiber with many wavelengths. In the context of the present invention, the total number of wavelengths that can be handled by the dynamic ADD architecture is thus normally 4, 8, 16, 20, 32, 40, 64 and 80.

As stated above, combined ADD signal 405 is routed to DEMUX 406 that demultiplexes it into demultiplexed signals 408 in a way such that each ADD signal is directed to its proper output (place), according to its wavelength. In other words, the combiner presents the sum of each input 402 mentioned above to the DEMUX, the latter sorting each wavelength to its proper place. DEMUX 406 is preferably implemented using an array waveguide (AWG) technology. Signals 408 sorted by N “ADD” wavelengths λ₁-λ_{N} exit the DEMUX and continue into a N*(2×1) ADD switch array 410, together with N “CONTINUE” signals 412 sorted by wavelengths λ*₁λ*_{N} and carried from left to right, for example by fiber 206 in FIG. 2.

A client can thus be connected to any free ADD port, and then it is automatically connected, without the need for software or a large matrix, to the proper place on N*(2×1) ADD switch array 410 according to the wavelength of its input. Note that in contrast with the usual mode of using a DEMUX, which is to decompose a multiplexed signal into its wavelengths constituents, in the architecture of the present invention the DEMUX is used to automatically sort into place a blend of inputs (e.g, as mentioned above, a single wavelength, a group of wavelengths, or the complete content of a fiber with many wavelengths). This is a non-obvious approach and mode of use of a DEMUX that results in a “passive” configuration providing fully dynamic configurability to an OADM.

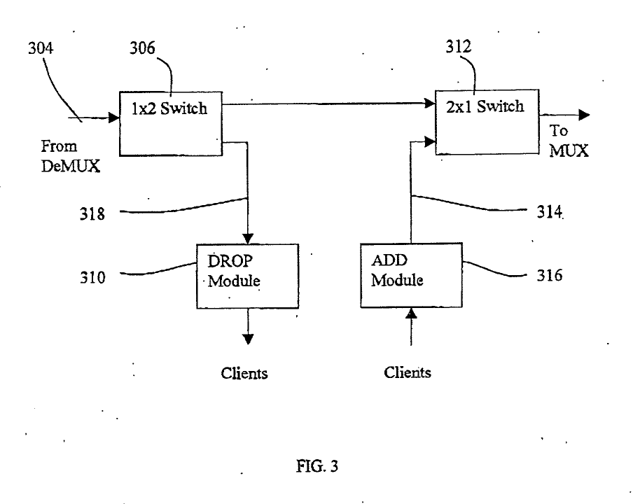

The architecture of dynamically adding optical signals to an OADM according to the present invention has additional advantages: the DEMUX passes only wavelengths that are on its grid and blocks all others. That is, if an attempt is made to add a signal either with offset from where it is supposed to be (a fault in the client equipment), or not on the expected grid (a wrong set up of client equipment), the DEMUX will not pass this signal. Although the MUX in FIG. 3 provides this protection automatically, DEMUX 406 is blocking any signal not on the grid at an earlier stage. An additional major advantage is the possibility to connect to an ADD port a fiber carrying a WDM multi-wavelength signal (e.g. a band arriving from another optical network element). In FIG. 5 it means that any of the 402 signals may be a multi-wavelength WDM signal. In addition to the obvious advantage of being able to connect to WDM signals which add mesh topology capabilities to the network, it provides also an opportunity to gather various signals of different wavelengths and WDM MUX them to be sent to the OADM ADD port via a single fiber. In the case there is only one such ADD input it also eliminates the need for the passive combiner within the OADM and hence eliminates the many fibers and ADD ports otherwise needed as well as the optical power penalty mentioned below. In FIG. 5, this means that there is only one 402 input signal that is directly connected to DEMUX 406, and that combiner 404, and its output signal 405 are removed.

A fully configurable ADD capability has its own merits even when fixed-tuned (constant wavelength transmitters) are connected to the client ADD ports. In this case the merit arises from letting the clients be connected in any arbitrary way, and from using the ADD module to reorder them. The ADD configurability is absolutely necessary if tunable wavelength transmitters are used at the ADD ports, since if such a transmitter changes wavelength then it must be rerouted to the proper ADD switch and MUX port. The benefit in using tunable wavelength transmitters is the much higher flexibility of the network. The added functionality arises from allowing each of the connected transmitters to assume any of the N wavelengths on the grid of the DEMUX (and MUX). Consequently, a client can get on the output port on any available “free” wavelength. Another advantage is a more efficient M:1 equipment protection. One “protection” transmitter can serve as a “spare” for M transmitters.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. In an all-optical network, a method for dynamically adding optical signals from at least one client to an optical section carrying N wavelengths, comprising:
a) obtaining from the at least one client a combined ADD signal that includes M ADD wavelengths where 1?M?N, and
b) inputting said combined ADD signal to a demultiplexer, said demultiplexer sorting each of said M ADD wavelengths into M sorted optical outputs, whereby the method provides a fully dynamically configurable OADM capability to the all-optical network using solely passive elements.

2. The method of claim 1, wherein said step of obtaining from the at least one client a combined ADD signal that includes M ADD wavelengths further includes providing a passive combiner and routing said M ADD wavelengths to said passive combiner, whereby said passive combiner outputs said combined ADD signal.

3. The method of claim 1, wherein said all-optical network includes an optical ring.

4. The method of claim 1, wherein said M ADD wavelengths include separate wavelengths.

5. The method of claim 1, wherein said M ADD wavelengths represent a WDM multi-wavelength signal.

6. The method of claim 2, further comprising combining said M sorted outputs with N continue wavelength-sorted signals, and feeding said combination into an N*(2×1) add switch array.

7. The method of claim 1, wherein said step of inputting said combined ADD signal to a demultiplexer includes inputting said combined ADD signal to an array waveguide demultiplexer.

8. The method of claim 1, wherein said M ADD wavelengths are selected from the group consisting of 4, 8, 16, 20, 32, 40, 64 and 80 wavelengths.

9. In an all-optical network, a dynamic ADD architecture for dynamically adding optical signals from at least one client to an optical section carrying N wavelengths, comprising:
a. a passive combiner for obtaining from the at least one client a combined ADD signal that includes M ADD wavelengths where 1?M?N, and
b. a demultiplexer for receiving said combined ADD signal from said passive combiner and for sorting each of said M ADD wavelengths into M sorted wavelengths each at a proper place, whereby the combination of said passive combiner and said demultiplexer provides a fully dynamically configurable OADM capability to the all-optical network using solely passive elements.

10. The dynamic ADD architecture of claim 9, wherein said all-optical network includes an optical ring.

11. The dynamic ADD architecture of claim 9, further comprising a N*(2×1) switch in optical communication with said demultiplexer and with the all-optical network, said N*(2×1) switch being fed said M sorted wavelengths and the N wavelengths.

12. The dynamic ADD architecture of claim 9, wherein said M ADD wavelengths include separate wavelengths.

13. The dynamic ADD architecture of claim 9, wherein said M ADD wavelengths represent a WDM multi-wavelength signal.

14. The dynamic ADD architecture of claim 9, wherein said demultiplexer includes an array waveguide demultiplexer.

15. The dynamic ADD architecture of claim 9, wherein said M ADD wavelengths are selected from the group consisting of 4, 8, 16, 20, 32, 40, 64 and 80 wavelengths.
